(19) United States
(12) Patent Application Publication
(10) Pub. No.: US 2011/0055072 A1
(43) Pub. Date: Mar. 3, 2011

(54) EVENT PROCESSING FOR DETECTION OF SUSPICIOUS FINANCIAL ACTIVITY

(75) Inventors: Alvin Lee, Charlotte, NC (US); Subramanian Sulur, Charlotte, NC (US); Carl Suplee, Huntersville, NC (US)

(73) Assignee: BANK OF AMERICA CORPORATION, Charlotte, NC (US)

(21) Appl. No.: 12/887,202

(22) Filed: Sep. 21, 2010

Related U.S. Application Data
(63) Continuation-in-part of application No. 12/550,942, filed on Aug. 31, 2009.

(51) Int. Cl. G06Q 40/00

(52) U.S. Cl. 705/38

(57) ABSTRACT

Event processing for detection of suspicious financial activity is disclosed. Financial events can be detected by receiving data from a plurality of detection channels. Events are consolidated or otherwise grouped based on common relationship factors, such as related accounts, related parties or the like. Factual data associated with the events, referred to herein as risk attributes, is collected and risk factors are assessed based on one or more of the risk attributes. The risk factors are subsequently used to determine whether an event group should be elevated to the case level for further investigation.

### CROSS-REFERENCE TO RELATED APPLICATION

This application is a continuation-in-part of co-pending patent application Ser. No. 12/550,942, filed Aug. 31, 2009, entitled “Event Processing for Detection of Suspicious Financial Activity”, assigned to the same inventive entity; the entire disclosure of which is incorporated herein by reference.

### FIELD

In general, embodiments herein disclosed relate to systems, methods, and computer program products for managing suspicious financial activity and, more specifically, systems, methods and computer program products for event processing for detection of suspicious financial activity.

### BACKGROUND

With the use of financial systems, products and the like by terrorists and other criminals to finance and support their activities, governments have promulgated guidelines and regulations to detect and monitor use of such systems and products. Compliance with these governmental guidelines and regulations can impose significant monetary and reputational burdens on financial institutions. Additionally, the financial institution itself may develop internal monitoring standards in order for the officers of the institution to safeguard the institution's assets against theft. Monitoring every transaction for the possibility of illicit or illegal activity can be a difficult task. Additionally, there may also be a need to document investigations and/or why certain actions were taken or not taken or document justification for a certain level of scrutiny placed on various customers.

### SUMMARY

The following presents a brief summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

A method for risk assessment of financial events defines first embodiments of the invention. The method includes receiving, via a computing device processor, financial event data from a plurality of event detection channels. The financial event data provides for detection of a plurality of financial events. The method additionally includes determining, via a computing device processor, an event group for each of the plurality of financial events. Each event group is defined by at least one common relationship factor. In addition, the method includes receiving, via a computing device processor, a plurality of risk attributes. Each risk attribute is associated with at least one of the financial events or one of the event groups. The method also includes determining, via a computing device processor, a plurality of risk factors for events within an event group. Each risk factor is based on one or more risk attributes. Moreover, the method includes determining, via a computing device processor, whether to promote an event group to a case level based on the risk factors associated with the event group.

In specific embodiments of the method, receiving financial event data further include receiving, via the computing device processor, the financial event data from a plurality of internal and external event detection channels.

In other specific embodiment the method includes receiving, via a computing device processor, the financial event data into an event interface record. The event interface record is configured to allow for financial event data to be received from the plurality of detection channels.

In still further specific embodiments the method includes enriching, via a computing device processor, the financial event data with one or more relationship factors prior to determining the event group for each of the plurality of financial events. In such embodiments enriching may further include enriching, via the computing device processor, the financial event data with the one or more relationship factors, such as related parties or related accounts.

In additional specific embodiments of the method includes determining an event group further comprises determining, via the computing device processor, the event group for each of the plurality of financial events. Each event group is defined by at least one common relationship factor, such as one or more of related accounts or related parties.

Moreover, in further embodiments of the method, wherein determining whether to promote the event group to the case level further includes assigning, via a computing device, a risk score for each of the risk factors associated with the event group, aggregating, via a computing device, the risk scores to result in an event group risk score, comparing, via a computing device processor, the event group risk score to a predetermined case threshold and promoting, via a computing device processor, the event group to the case level if the event group risk score meets or exceeds the case threshold.

Additional specific embodiments of the method include validating, via a computing device processor, event defining criteria by random sampling of event groups that have not yet been promoted to the case level. Still further embodiments of the method include generating, via a computing device processor, a case narrative associated with a case for inclusion in a suspicious activity report. The case narrative is automatically generated based on the associated financial event data, risk attributes and risk factors.

An apparatus for risk assessment of financial events provides for second embodiments of the invention. The apparatus includes a computing device including a memory and a processor. The apparatus further includes a financial event risk assessment module stored in the memory and executable by the processor. The module includes an event data collection routine configured to collect financial event data from a plurality of event detection channels and detect financial events based on the financial event data. The module further includes an event consolidation routine configured to group each of the plurality of financial events into an event group. Each event group is defined by at least one common relationship factor. In addition, the module includes a risk attribute collection routine configured to collect a plurality risk attributes. Each risk attribute is associated with at least one of the financial events or one of the event groups. Additionally, the module includes a risk factor determination routine configured to determine a plurality of risk factors for events within an event group. Each risk factor is based on one or more risk attributes. Moreover, the module includes a case promotion routine configured to determine whether to promote an event group to a case level based on the risk factors associated with the event group.

In specific embodiments of the apparatus, the event data collection routine is further configured to collect financial event data from the plurality of internal and external event detection channels.

In other specific embodiments of the apparatus, the financial event risk assessment module further includes an event interface record routine configured to receive the financial event data into an event interface record. The event interface record is configured to allow for financial event data to be received from the plurality of detection channels.

In still further specific embodiments of the apparatus, the financial event risk assessment routine further includes an event data enrichment routine configured to enrich the financial event data with one or more relationship factors prior to determining the event group for each of the plurality of financial events. In such embodiments, the relationship factors may include one or more of related parties or related accounts.

In additional embodiments of the apparatus the event consolidation routine is further configured to group each of the plurality of financial events into an event group. Each event group is defined by at least one common relationship factor, such as one or more of related account or related party.

In still other embodiments of the apparatus, the case promotion routine further includes a risk score subroutine configured to assign a risk score for each of the risk factors associated with the event group, a risk score aggregator subroutine configured to aggregate the risk scores to result in an event group risk score, and a case threshold comparison subroutine configured to compare the event group risk score to a predetermined case threshold and promote the event group to the case level if the event group risk score meets or exceeds the case threshold.

Moreover, in additional embodiments of the apparatus, the financial event risk assessment module further includes an event validation routine configured to validate event-defining criteria by random sampling of event groups that have not yet been promoted to the case level. In additional embodiments of the apparatus, the financial event risk assessment module further includes a case narrative generating routine configured to generate a case narrative associated with a case for inclusion in a suspicious activity report. The case narrative is automatically generated based on the associated financial event data, risk attributes and risk factors.

A computer program product including a non-transitory computer-readable medium defines third embodiments of the invention. The computer-readable medium includes a first set of codes for causing a computer to receive financial event data from a plurality of event detection channels. The financial event data provides for detection of a plurality of financial events. Additionally, the computer-readable medium includes a second set of codes for causing a computer to determine an event group for each of the plurality of financial events. Each event group is defined by at least one common relationship factor. The computer-readable medium additionally includes a third set of codes for causing a computer to receive a plurality of risk attributes. Each risk attribute is associated with at least one of the financial events or one of the event groups. In addition, the computer-readable medium includes a fourth set of codes for causing a computer to determine a plurality of risk factors for events within an event group. Each risk factor is based on one or more risk attributes. Moreover, the computer-readable medium includes a fifth set of codes for causing a computer to determine whether to promote an event group to a case level based on the risk factors associated with the event group.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a flowchart depiction of a method for risk assessment and case promotion, in accordance with embodiments of the present invention;

FIG. 2 is a flowchart illustrating the overall process for risk factor assessment and case promotion, in accordance with at least one example embodiment of the present invention;

FIG. 3 is block diagram depiction if an event interface record, in accordance with embodiments of the present invention;

FIG. 4 is a combination flowchart and system diagram illustrating a risk scoring process, according to at least some embodiments of the present invention; and

FIG. 5 is a record layout of the risk scoring process, according to at least some embodiments of the present invention.

### DETAILED DESCRIPTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

Embodiments of the present invention are disclosed, by way of example, as a module, application, tool or the like used in a financial institution to assess risk, and record details in connection with financial events that may constitute fraudulent activity. It cannot be overemphasized that this environment is illustrated as an example only, and an embodiment of the invention can be used in any kind of business, non-profit organization, or government organization. With respect to the example of a bank or financial institution, the term “bank” or the synonymous term “financial institution” and any similar terms are used herein in their broadest sense. Financial institutions that process transactions of the types discussed can include stock brokerages, credit unions, and other types of institutions which are not strictly banks in the historical sense. The term “financial institution” refers to an institution that acts as an agent to provide financial services for its customers or members. Financial institutions generally, but not always, fall under financial regulation from a government authority. Financial institutions include, but are not limited to, banks, building societies, credit unions, stock brokerages, asset management firms, savings and loans, money lending companies, insurance brokerages, insurance underwriters, dealers in securities, and similar businesses. The use of terms such as “bank”, “financial institution” or “franchise” herein is meant to encompass all such possibilities.

The financial crimes event processing system according to example embodiments of the invention captures event data, such as raw transaction or experience data from a variety of detection channels, including, but not limited to, anti-money laundering systems, corporate security systems, financial accounts systems and systems external to the financial institution. As herein described, all event data is formatted according to Event Interface Records (EIRs). An EIR layout allows capture of an undefined number of data elements and values from the various detection channels. The standard and universal EIR layout enables reusability of the core process regardless of the detection channels and sources. Thus, the EIR layout herein described reduces the setup time for new detection channel events.

According to specific embodiments of the invention, event data is enriched or otherwise supplemented by providing additional detail about the event, which includes, but is not limited to, related parties and related account information. With the additional information, events can be consolidated into event groups. Unlike other prior arts building around individual alert reviews, event groups include, not only associated suspicious activities but also, potential parties, accounts and products involved. Thus, event groups provide fore a more complete holistic view of the activities can be presented for thorough assessment and investigation.

Parallel to the core process, a set of configurable logics and parameters are maintained under a risk profile, which includes, but is not limited to, risk attribute definitions, risk attribute logics (i.e., instructions for collecting risk attributes), risk factor definitions, risk factor logics (i.e., instructions for determining risk factors based on risk attributes), random sampling parameters and scopes, and case-determining risk score thresholds. A Risk Profile User Interface (RPUI) is used to provide for data entry as well as to ensure a high level of data quality and integrity for production use. The RPUI enforces manager review and proper audit trails when promoting the parameters into production. A unique risk profile identifier is assigned to every version of a risk profile. The risk profile identifier may be stored in all resulting records generated by the process to ensure traceability of the configuration changes.

The risk attribute collection process is a fact finding process. Risk attributes can be any information collected from normal business transactions, law enforcement enquiry, government published watch list, prior cases investigated against one or more parties involved in the event groups or the like. Risk attribute logic is the group of cross-platform codes (such as Structured Query Language (SQL)) and parameters captured and stored within the RPUI. The logic instructs the core process during execution on where, what and how to collect the risk attribute for any objects within the event group. Risk attributes for an event and/or event group may be collected only once or on a regular basis to reflect the latest updates, for example if an individual is a Senior Foreign Political Figure (SFPF).

A risk factor is a risk assessment of specific suspicious activities (such as terror financing, money laundering, etc.) based on one or more of the risk attributes. The risk factor logic is a set of logic to instruct the core process how the risk factor may be assessed or otherwise determined based upon one or more of the collected risk attributes. All of the risk attributes within an event group are assessed by risk factor logic to determine risk factors associated with an event, a group of events or a combination of associated objects (e.g., a party, and account or the like) under a group of events. According to specific embodiments of the invention, each resulting risk factor correlates with either a risk score or a risk action. Once all risk factors have been determined for all objects within an event group, the risk scores are aggregated to result in an overall group risk score and the risk actions are consolidated to result in overall risk actions for the event group. The overall group risk score is compared to a case threshold to determine whether the event group should be promoted to the case level. In addition, the overall risk actions are assessed to determine if any of the risk actions are predetermined as requiring case promotion. If the event group risk score meets or exceeds the case threshold or if any of the event group risk actions are deemed to require case promotion, the event group is promoted to the case level.

Event groups are further enriched and formatted prior to case promotion within a case interface for specific information required by the case management system. In additional embodiments, a pre-scripted case story, which is implemented in a case report (e.g., Suspicious Activity Report (SAR)) may be generated in narrative form from the risk attributes collected. Case allocation and assignment decision may be driven by logics, similar to those used in risk attribute and risk factor, and maintained within the RPUI. All enriched information may be sent to the case management system and investigators for final review and filing.

The event groups that fail to meet the case threshold may be kept within the process as “non-case” event groups. The processes of consolidation, risk attribute collection and risk factor determination/risk scoring may be repeated on a regular basis until the event group meets or exceeds the case threshold and becomes a case or, in the event the case threshold is not subsequently met or exceeded, the case is retired when reaching certain criteria (such as age).

Further, randomized samples may be taken from the non-case event groups, with the size of the sample being determined in advance inside the RPUI, based on the sample size needed for statistical validity during a model validation cycle. Randomly sampled event groups can be submitted as cases, and these may be used to determine if the criteria and thresholds used to create the events are strongly associated with suspicious activity reports. The random samples can be used to identify the extent to which false negatives are present within event detection channels, and if scenario tuning is needed.

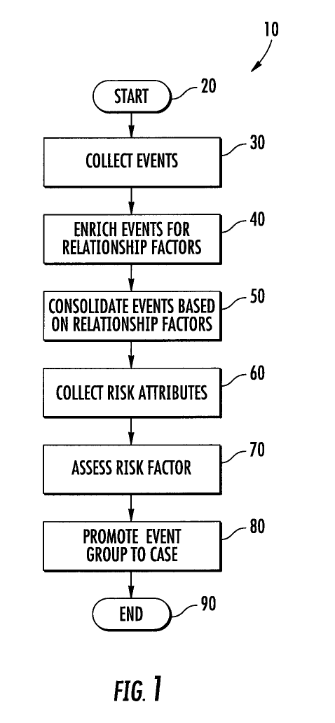

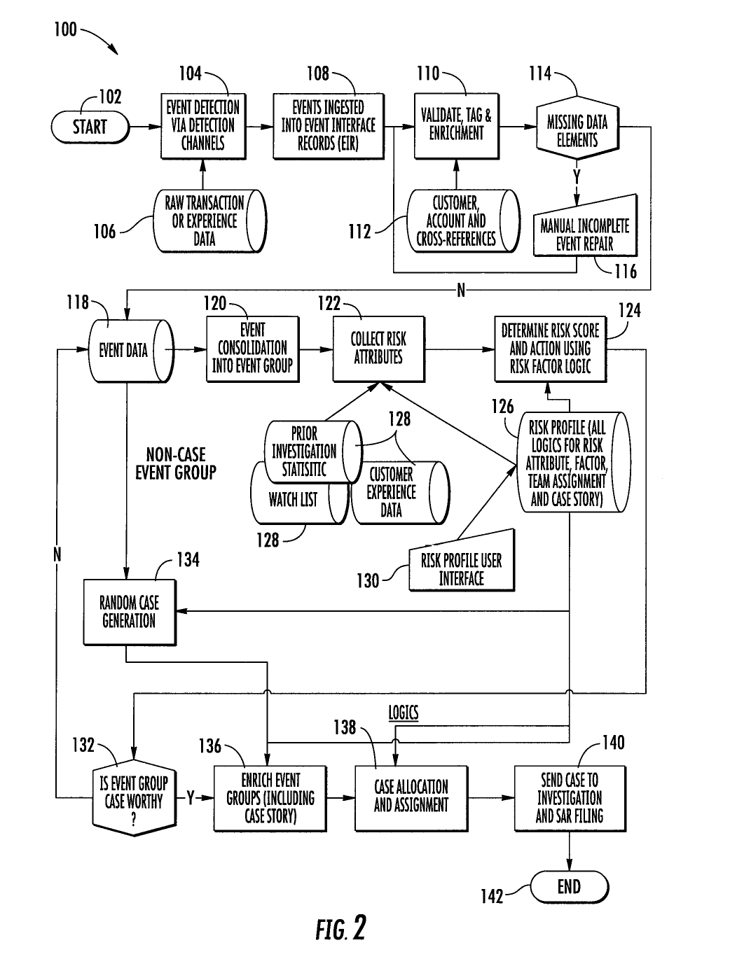

Referring to FIG. 1 a high level flow diagram is presented of a method 10 for risk assessment and case promotion, in accordance with embodiments of the present invention. At block 20 the process of risk assessment and case promotion is initiated. At block 30, a plurality of events is collected from a plurality of detection channels. In the financial realm embodiments, the events may be transactions or any other recorded contacts/incidents with the financial institution. The detection channels may be internal or external channels. For example, in the financial institution embodiments, the detection channels may include, but are not limited to, anti-money laundering systems, corporate security systems, financial accounts systems and systems external to the financial institution

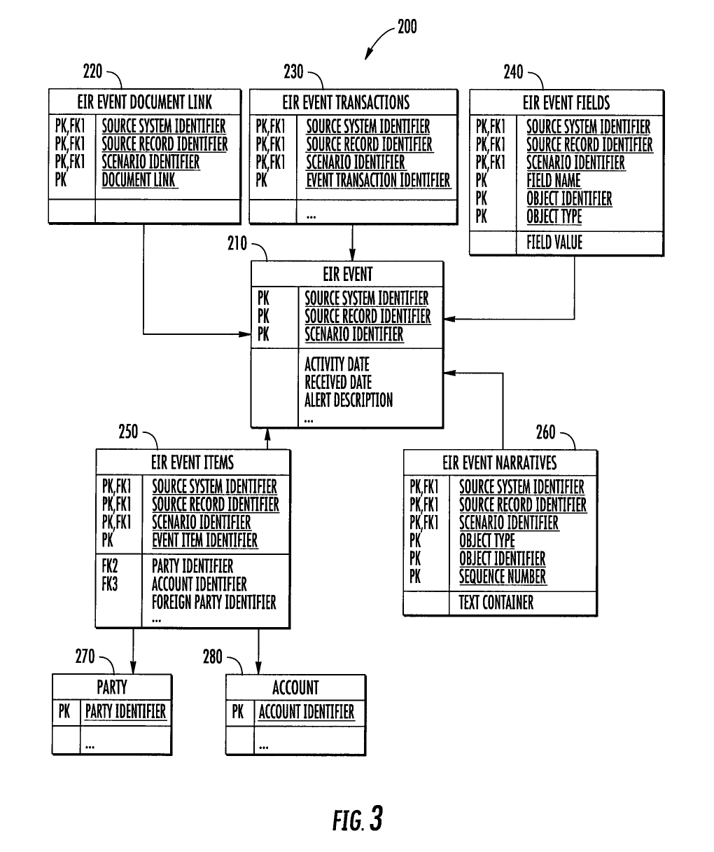

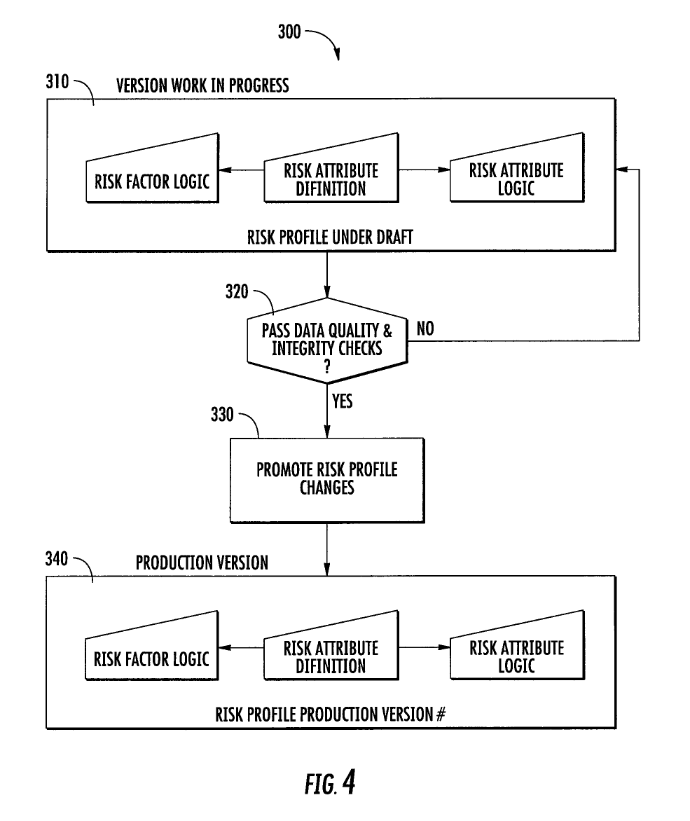

The collected events are subsequently ingested or otherwise incorporated into Event Interface Records (EIRs) (not shown in FIG. 1). The EIRs, which are shown and described in detail in relation to FIG. 3, infra., are a universal interface that provides for events to be collected from a plurality of diverse detection channels and for new detection channels to implemented in the event collection process without reconfiguration or adjustment of the collection process.

At optional block 40, the event data is enriched by determining relationship factors, such as associated parties, related parties, associated accounts, related account. Associated parties or associated accounts are the parties and accounts associated with the event. Related parties or related accounts are the parties or accounts related to the parties and accounts associated with the event. Internal databases may be searched to determine relationship factors.

At block 50, the events are consolidated into event groups, where each event group is defined by one or more relationship factors, such as common parties, common accounts or the like. Each event group includes multiple events and each event is consolidated into a single event group. By consolidating events into event groups based on relationship factors, a holistic approach to risk assessment and evaluation is realized. Consolidation of events into event groups is an ongoing process as more and more events occur over time.

At block 60, risk attributes are collected for events within an event group. The risk attributes are factual information associated with an event or an event group. Thus, the factual information otherwise referred to herein as “objects”, are associated with an event, data related to an event or a combination of data related to more than one event within an event group. The risk attribute logic will be configured to define the risk attributes.

At block 70, risk factors are assessed or otherwise determined based on one and typically a collection of risk attributes. Risk factor logic is configured to determine which risk attributes or combination of risk attributes give rise to a risk factor. In specific embodiments, each of the risk factors correlate to a risk score, which provides a qualitative indication of the risk factor's worthiness to give rise or promote the event group associated with the risk factor to the level of a risk case. Once a risk case is defined, further investigation is undertaken by case analysts or the like to determine the actual risk imposed by the events and/or risk factors in the event group which defines the case. All of the risk scores associated with events within an event group may be aggregated to determine a cumulative event group risk score and that aggregated risk score may be compared to a case-determining threshold to determine whether the level of risk associated with an event group warrants the event group be elevated or otherwise promoted to the case level. In addition to risk scores, specific actions or events within an event group, as defined by the risk factor logic, may give rise to an event group being promoted to the case level.

At block 80, once an event group has been promoted to the case level, additional enrichment of the data may be performed and investigation of the case is conducted by case analysts. At block 90, the process ends.

FIG. 2 is a more detailed flowchart of a method 100 for risk assessment and case promotion; in accordance with embodiments of the present invention. FIG. 2 also illustrates how various data are used in carrying out the process. Like most flowchart illustrations, FIG. 2 illustrates method 100 as a plurality of process and/or sub-process blocks presented in sequence. Various data that are input and/or output from the process are schematically shown as storage media. Process 100 begins at block 102. At block 104, events are detected through one of various detection channels. Detection channels are interfaces to processes or business units that detect events based on transaction data or experience data, shown at input 106, matching a predefined pattern. Records associated with the event are generated and determined to meet pre-determined risk-based criteria for further processing to determine if the event merits the generation of a case for investigation. Although detection channels have varying data and record formats within their own processing environments, the data being passed on to the event processor, in accordance with an embodiment of the invention, is normally formatted as an EIR, at block 108 of FIG. 2. According to specific embodiments, the EIR may be staged by the detection channels and made available to the event processor. Additionally, embodiments of the present invention provide for the EIR to be in one of the following file formats, although other formats could be implemented: XML (eXtension Markup Language); comma or tab separated values; or a flat file with delimiters in between distinct blocks of information. Details related to the EIR will be discussed in reference to FIG. 3, infra.

Still referring to FIG. 2, validation, tagging and data enrichment take place at block 110. A detection channel event is tagged and assigned a unique system-generated identifier. A portion of the detection channel event is copied into an event record with another system-generated identifier. A linkage is established in the event record back to the detection channel event record. Thus, the original data values within the record can be retained throughout the process. Data quality checks are performed to ensure that required data elements are available and are valid. At input 112, an attempt is made, for events that do not have account consolidation information, to locate the missing data elements from the customer/account database. At block 114, a determination is made as to whether, after attempts to locate missing information, there are still missing data elements in the EIR. If the determination is made that there missing data elements in the EIR, at block 116, a manual incomplete event repair process occurs. The manual incomplete event repair process provides analysts the capability of reviewing events with missing data elements through a graphical user interface. Required data elements may be added if available. Modified records are flagged and staged in a repaired events queue. In the next event processor scheduled cycle run, the system detects these modified event records for the purpose of including the modifications in the process. If the determination is made that there are no missing data elements in the EIR, at block 118, events are stored in the event database.

Process 100 proceeds to block 120, where events that have all the necessary data elements are consolidated, otherwise referred to herein as grouped, based on relationship factors, such as customer account relationship, party relationship and the like. Logical grouping of events are assigned a system-generated unique identifier. An event group may include a single event or, in most instances, multiple events.

At block 122, risk attributes are collected from various sources, such as inputs 128, including, but not limited to, prior case investigation statistics, watch lists, customer experience data and the like. The risk profile 126 provides risk attribute definitions and risk attribute logics, which indicate what, where and how risk attributes are to be collected. The risk profile 126 is maintained by the risk profile user interface (RPUI) 130. The Risk Profile User Interface (RPUI) 130 allows configuration analysts to add, remove and/or update configuration parameters and logic to vary the core processing logic as needed. The risk profile 126 or any portion of the risk profile 126 may require review and/or approval for production use, via enforcement by the RPUI 130. Once the risk profile 126 has been approved, it is “promoted” to storage for subsequent batch processing/production use.

Collected risk attributes are subsequently stored at various levels of aggregation, such as, but not necessarily limited to, event, event group, party, account level and the like. Based on the levels of aggregation, the risk attributes are associated. Once the risk attributes are collected, at block 124, risk factor logic is executed to determine risk factors based on the risk attributes and to correlate the risk factors to risk scores. The risk profile 126 provides the risk factor definitions and risk factor logic, which indicates the one or more risk attributes that result in a risk factor and the correlated risk score. The individual risk factors are created such that they represent the incremental probability that the risk factor, if present, contributes to the likelihood of the nature of the event group necessitating the filing of a suspicious activity report by an investigator.

At block 132, a determination is made as to whether an event group is case-worthy. The determination is based on the risk score and actions for the event group. The aggregated score for all the risk factors in the event group is summed and compared to a case threshold for the purpose of making a decision as to whether a case for investigation is to be programmatically generated. Further, at block 134, statistical sampling of the non-case event groups (i.e., event groups for which the risk factor score is below the case threshold) will result in the non-case event groups being treated as cases, for the purpose of testing. The logic required for statistical sampling of the non-case events is provided by the risk profile 126.

At block 136, event groups that will subsequently be promoted to the case level are enriched with additional information. Event information, associated accounts and transaction data that may be involved in a case is formatted according to the case interface record, which is specific to case management system requirements. The case interface record, according to specific embodiments, may be in one of the following file formats, although other formats may generally be implemented: XML, Excel® (Microsoft® Corporation of Redmond, Wash.) spreadsheet; comma or tab separated values; a flat file with delimiters between distinct blocks of information or the like. A case story, which is a system generated narrative, may be generated from risk attribute, risk factor and event information. The logic required to generate the case story is provided by risk profile 126. At block 138, cases are allocated based on predefined sets of parameters and logic provided by the risk profile 126. Case allocation is the assigning of a case to a specific team of investigators. In some entities, certain investigation teams are responsible for handling specific types of cases. The parameters and logic take into consideration the available resources and current queue of outstanding cases. Additionally, the case assignment logic of the system takes into consideration the risk factors associated with the event or groups of events and the staffing level of each investigation team.

Finally, at block 140, cases are investigated and, at block 142, process 100 of FIG. 2 ends.

FIG. 3 provide a schematic representation of the data structure 200 of an Event Interface Record (EIR); in accordance with embodiments of the present invention. The EIR data structure shown in FIG. 3 is the standard layout that is generic and universal to all detection channel events. The EIR includes an event header record 210, which includes a source system identifier, a source record identifier and a scenario identifier. As such, each EIR can be uniquely identified by either the source system identifier, the source record identifier or the scenario identifier. The source system identifier is the unique identifier of the system from which events are collected. The source record identifier serves to identify an alert within the detection channel source system. The scenario identifier is a common identifier defined by the event processor for each scenario qualified by the associated detection channel. The activity date, received date and alert description are examples of other characteristic data stored in the event header record 210 and should not be construed as limiting. The activity date reflects the date(s) of the event, the received date reflects the date the event was collected/received and the alert description reflects the specific of the event.

Still referring to FIG. 3, associated information is attached to the EIR with the three combined key structures (i.e., source system identifier, source record identifier and scenario identifier) which serve to identify the event associated with the record. The associated information may include, but is not limited to, document links 220, event transaction records 230, event field records 240, event item records 250 and event narrative records 260. In addition to the three combined key structures, document link 220 includes one or more links to additional document concerning the event, such as a screen shot of a web search or the like. Event transaction records 230 include event transaction identifier(s) and contributing transaction information associated with the event. Event fields records 240 include the field names, as well as essential name value pairs of data elements associated with the objects (identified by the object type and object identifier) within the event. Event item records 250 include event item identifier(s), a party identifier 270 or foreign party identifier, (e.g. driver license number, passport number or the like) and an account identifier 280, including account information associated with the event. Narrative records 260 include an object type, object identifier, sequence number and human review intelligence documented in narrative form.

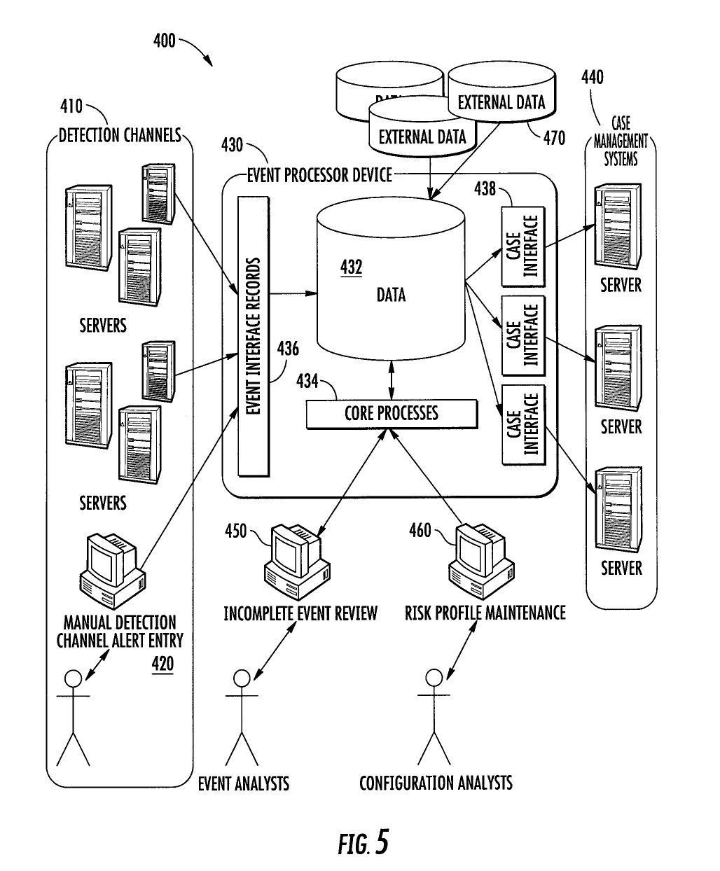

Referring to FIG. 4 a flow diagram 300 is depicted of a risk profile promotion process; in accordance with an embodiment of the present invention. A risk profile is “promoted when the risk profile is moved from a work-in-progress stage to a production use stage. With a large number of highly configurable parameters and logics, it is necessary to maintain integrity among parameters and logics. For example, risk factor logic is dependent upon defining risk attribute(s). Similarly, the risk attribute logic must be properly functioning in order for risk attributes to result. Risk profile represents a highly integrated set of configurations, including risk attributes, risk factors, risk factor logic, risk attribute logic, case story logic, team assignment logic, statistical sampling non-case event group parameters, case threshold and the like. Individual components are part of the overall configuration and require review and promotion as a whole to affect changes to the risk profile.

Block 310 of FIG. 4 represents a work-in-progress configuration of risk profile. Risk attributes are defined and, based on the defined risk attributes, the risk attribute logic and the risk factor are defined. Prior to implementing the promotion, at decision block 320, a determination as made as to whether the configuration set-up is error free. Data quality and integrity checks are performed to ensure that the configuration set-up is error free. If the configuration set-up is determined to be include errors, the process returns to block 310 for further work-in-progress processing to correct the errors. If the configuration set-up is determined to be error free, at block 330, a unique version is assigned to the risk profile and the risk profile is promoted the production version, shown in block 340. As enforced by the Risk Profile User Interface (RPUI), only authorized personnel are allowed to promote the risk profile. The unique risk profile version number is assigned and attached to all resulting risk attributes and factors generated for the purpose of retaining traceability. The production version of the risk profile, shown in block 340, represents production versions of the risk attributes, the risk attribute logic, the risk factor logic and the like.

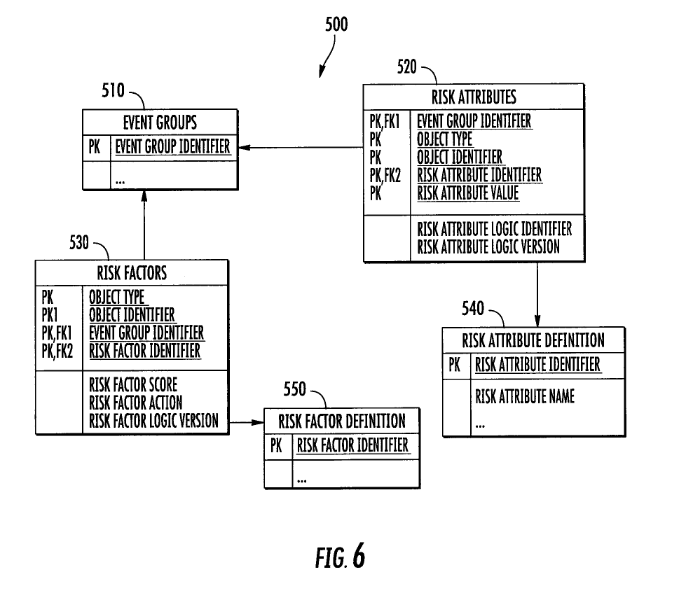

FIG. 5 is a block diagram depiction of a system 400 and operating environment for implementing risk assessment and case promotion, in accordance with embodiments of the present invention. Event processor device 430 is a mainframe or mid-range computing system including a processor and supporting circuitry to execute the appropriate instructions. Additionally, event processor device 430 includes a fixed storage medium 432 that is configured to store computer program product code 434 for conducting the core processes of the present invention. In addition, the storage medium 432 is configured to store data, such as event database 118, configuration database 126 and the like. Other storage media 470 is configured to store data required for processing, including customer account data 112, prior investigation statistics, watch list and customer experience data, shown collectively as data 128.

Still referring to FIG. 5, exemplary detection channels 410 include web servers, application servers and the like, which may be used for on-line services, other client server applications, other main frame applications and the like. In addition, detection channels 410 may include workstation 420 configured for manual entry of events.

Workstation 450 is configured for incomplete event review. An event analyst that specializes in repairing incomplete event interfaces with workstation 450. Work station 460 is configured to execute the Risk Profile User Interface (RPUI). A configuration analyst that specializes in configuring all parameters and logics interfaces with workstation 460.

The processor 430 additionally includes EIR staging area 436 that receives event data from detection channels 410 and formats event record for the detected events. In addition, processor 430 includes case interface records 438 that are communicated to case management system 440.

Thus, embodiments previously described provide for event processing for detection of suspicious financial activity. In specific, financial events can be detected by receiving data from a plurality of detection channels. Detected events are subsequently consolidated or otherwise grouped based on common relationship factors, such as related accounts, related parties or the like. Factual data associated with the events, referred to herein as risk attributes, is collected and risk factors are assessed based on one or more of the risk attributes. The risk factors are subsequently used to determine whether an event group should be elevated to the case level for further investigation. Specifically, a risk factor score may be compared to a threshold or specific risk actions or combinations or risk actions may elevate an event group to the case level.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. Additionally, comparative, quantitative terms such as “above”, “below”, “less”, “greater”, are intended to encompass the concept of equality, thus, “less” can mean not only “less” in the strictest mathematical sense, but also, “less than or equal to.”

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. A method for risk assessment of financial events, the method comprising:
receiving, via a computing device processor, financial event data from a plurality of event detection channels, wherein the financial event data provides for detection of a plurality of financial events;
determining, via a computing device processor, an event group for each of the plurality of financial events, wherein each event group is defined by at least one common relationship factor;
receiving, via a computing device processor, a plurality of risk attributes, wherein each risk attribute is associated with at least one of the financial events or one of the event groups;
determining, via a computing device processor, a plurality of risk factors for events within an event group, wherein each risk factor is based on one or more risk attributes; and
determining, via a computing device processor, whether to promote an event group to a case level based on the risk factors associated with the event group.

2. The method of claim 1, wherein receiving financial event data further comprises receiving, via the computing device processor, the financial event data from a plurality of event detection channels, wherein the event detection channels are internal and external event detection channels.

3. The method of claim 1, further comprising receiving, via a computing device processor, the financial event data into an event interface record, wherein the event interface record is configured to allow for financial event data to be received from the plurality of detection channels.

4. The method of claim 1, further comprising enriching, via a computing device processor, the financial event data with one or more relationship factors prior to determining the event group for each of the plurality of financial events.

5. The method of claim 4, wherein enriching further comprises enriching, via the computing device processor, the financial event data with the one or more relationship factors, wherein the relationship factors include one or more of related parties or related accounts.

6. The method of claim 1, wherein determining an event group further comprises determining, via the computing device processor, the event group for each of the plurality of financial events, wherein each event group is defined by at least one common relationship factor, wherein the common relationship factor is one or more of related account or related party.

7. The method of claim 1, wherein determining whether to promote the event group to the case level further comprises:
assigning, via a computing device, a risk score for each of the risk factors associated with the event group;
aggregating, via a computing device, the risk scores to result in an event group risk score;
comparing, via a computing device processor, the event group risk score to a predetermined case threshold; and
promoting, via a computing device processor, the event group to the case level if the event group risk score meets or exceeds the case threshold.

8. The method of claim 1, further comprising validating, via a computing device processor, event defining criteria by random sampling of event groups that have not yet been promoted to the case level.

9. The method of claim 1, further comprising generating, via a computing device processor, a case narrative associated with a case for inclusion in a suspicious activity report, wherein the case narrative is automatically generated based on the associated financial event data, risk attributes and risk factors.

10. An apparatus for risk assessment of financial events, the apparatus comprising:
a computing device including a memory and a processor; and
a financial event risk assessment module stored in the memory, executable by the processor and including,
an event data collection routine configured to collect financial event data from a plurality of event detection channels and detect financial events based on the financial event data,
an event consolidation routine configured to group each of the plurality of financial events into an event group, wherein each event group is defined by at least one common relationship factor,
a risk attribute collection routine configured to collect a plurality risk attributes, wherein each risk attribute is associated with at least one of the financial events or one of the event groups;
a risk factor determination routine configured to determine a plurality of risk factors for events within an event group, wherein each risk factor is based on one or more risk attributes; and
a case promotion routine configured to determine whether to promote an event group to a case level based on the risk factors associated with the event group.

11. The apparatus of claim 10, wherein the event data collection routine is further configured to collect financial event data from the plurality of event detection channels, wherein the event detection channels are internal and external event detection channels.

12. The apparatus of claim 10, wherein the financial event risk assessment module further comprises an event interface record routine configured to receive the financial event data into an event interface record, wherein the event interface record is configured to allow for financial event data to be received from the plurality of detection channels.

13. The apparatus of claim 10, wherein the financial event risk assessment routine further comprises an event data enrichment routine configured to enrich the financial event data with one or more relationship factors prior to determining the event group for each of the plurality of financial events.

14. The apparatus of claim 13, wherein the event data enrichment routine is further configured to enrich the financial event data with the one or more relationship factors, wherein the relationship factors include one or more of related parties or related accounts.

15. The apparatus of claim 10, wherein the event consolidation routine is further configured to group each of the plurality of financial events into an event group, wherein each event group is defined by at least one common relationship factor, wherein the common relationship factor is one or more of related account or related party.

16. The apparatus of claim 10, wherein the case promotion routine further comprises:
a risk score subroutine configured to assign a risk score for each of the risk factors associated with the event group;
a risk score aggregator subroutine configured to aggregate the risk scores to result in an event group risk score;
a case threshold comparison subroutine configured to compare the event group risk score to a predetermined case threshold and promote the event group to the case level if the event group risk score meets or exceeds the case threshold.

17. The apparatus of claim 10, wherein the financial event risk assessment module further comprises an event validation routine configured to validate event-defining criteria by random sampling of event groups that have not yet been promoted to the case level.

18. The apparatus of claim 10, wherein the financial event risk assessment module further comprises a case narrative generating routine configured to generate a case narrative associated with a case for inclusion in a suspicious activity report, wherein the case narrative is automatically generated based on the associated financial event data, risk attributes and risk factors.

19. A computer program product comprising:
a non-transitory computer-readable medium comprising:
a first set of codes for causing a computer to receive financial event data from a plurality of event detection channels, wherein the financial event data provides for detection of a plurality of financial events;
a second set of codes for causing a computer to determine an event group for each of the plurality of financial events, wherein each event group is defined by at least one common relationship factor;
a third set of codes for causing a computer to receive a plurality of risk attributes, wherein each risk attribute is associated with at least one of the financial events or one of the event groups;
a fourth set of codes for causing a computer to determine a plurality of risk factors for events within an event group, wherein each risk factor is based on one or more risk attributes; and
a fifth set of codes for causing a computer to determine whether to promote an event group to a case level based on the risk factors associated with the event group.

20. The computer program product of claim 19, wherein the first set of codes is further configured to cause the computer to receive the financial event data from a plurality of event detection channels, wherein the event detection channels are internal and external event detection channels.

21. The computer program product of claim 19, further comprising a sixth set of codes for causing a computer to receive the financial event data into an event interface record, wherein the event interface record is configured to allow for financial event data to be received from the plurality of detection channels.

22. The computer program product of claim 19, further comprising a sixth set of codes for causing a computer to enrich the financial event data with one or more relationship factors prior to determining the event group for each of the plurality of financial events.

23. The computer program product of claim 22, wherein the sixth set of codes is further configured to cause the computer to enrich the financial event data with the one or more relationship factors, wherein the relationship factors include one or more of related parties or related accounts.

24. The computer program product of claim 19, wherein the second set of codes is further configured to cause the computer to determine the event group for each of the plurality of financial events, wherein each event group is defined by at least one common relationship factor, wherein the common relationship factor is one or more of related account or related party.

25. The computer program product of claim 19, wherein the fifth set of codes is further configured to cause the computer to assign a risk score for each of the risk factors associated with the event group, aggregate the risk scores to result in an event group risk score, compare the event group risk score to a predetermined case threshold and promote the event group to the case level if the event group risk score meets or exceeds the case threshold.

26. The computer program product of claim 19, further comprising a sixth set of codes for causing a computer to validate event-defining criteria by random sampling of event groups that have not yet been promoted to the case level.

27. The computer program product of claim 19, further comprising a sixth set of codes for causing a computer to generate a case narrative associated with a case for inclusion in a suspicious activity report, wherein the case narrative is automatically generated based on the associated financial event data, risk attributes and risk factors.
